(19) United States
(12) Patent Application Publication
(10) Pub. No.: US 2006/0207236 A1
(43) Pub. Date: Sep. 21, 2006

(54) Grass and leaf collector bag for a lawn tractor

(76) Inventor: Kenneth Leonard, Midlothian, VA (US)

Correspondence Address: JACOBSON HOLMAN PLLC, 400 SEVENTH STREET N.W., SUITE 600, WASHINGTON, DC, 20004, US

(21) Appl. No.: 11/368,389

(22) Filed: Mar. 7, 2006

Related U.S. Application Data
(60) Provisional application No. 60/662,817, filed on Mar. 18, 2005.

(51) Int. Cl. A01D 43/06

(52) U.S. Cl. 56/202

(57) ABSTRACT

A grass and leaf-clipping collector bag for lawn tractors designed to provide the ability to collect a significantly large volume of grass and leaves in a closed container before requiring emptying or disposal. The grass and leaf-collector bag attaches to the exhaust chute of the mower attachment on a lawn tractor. The bag is easily attached and removed from the exhaust chute using a quick release mechanism and is dragged on the ground behind the lawn tractor.

### CROSS-REFERENCE TO RELATED APPLICATIONS

The present patent application is based on, and claims priority from, U.S. provisional Application No. 60/662,817, filed Mar. 18, 2005, which is incorporated herein by reference in its entirety.

### BACKGROUND OF THE INVENTION

1. Field of the Invention

This invention relates to grass and leaf collection devices for lawn tractors. More specifically the invention simplifies the collection of and significantly increases the volume of grass and leaf clippings that can be collected in a closed container using the lawn tractor and mower attachments before disposing of the collected material when compared to existing devices.

2. Related Art

It is common to equip a lawn tractor with an optional device to collect the grass and leaf clippings generated by the mower attachment. In the presently available devices, the collection containers are in communication with the hood of a grass catcher assembly that either maintains the necessary airflow and directs the clippings into small closed containers that are supported off the ground or directs the clippings into an open container being dragged behind the lawn tractor. There is presently no device for collecting the grass and leaf clippings without using the hood of the grass catcher assembly or for collecting significantly large quantities of clippings in a closed container.

One example of prior art is U.S. Pat. No. 4,532,755 to Schemelin et al, which discloses a common device using small collection containers requiring supports to keep them off the ground and having an outlet vent in the hood of a grass catcher assembly to maintain airflow.

U.S. Pat. No. 6,651,414 to Sowers discloses a collection sled for a lawn tractor that is open and drags behind the lawn tractor on the ground. This collection sled attaches to the hood of the grass catcher assembly.

U.S. Pat. No. 5,546,738 to Turner discloses an open rigid container that that is dragged behind the lawn tractor and is in communication with the hood of the grass catcher assembly that directs the clippings into the container.

### SUMMARY OF THE INVENTION

It is the primary objective of the invention to provide a collection bag with the ability to easily collect a large volume of grass and leaf clippings using a lawn tractor with a mower attachment.

It is another object of the present invention to provide a collection bag that is easily attached and removed from the lawn tractor mower attachment exhaust chute.

It is still another object of the present invention to provide a collection bag that is easily attached and removed from an existing grass catcher already attached to the lawn tractor mower attachment.

It is still another object of the invention to provide a collection bag that attaches to the lawn tractor and drags on the ground behind the lawn tractor, eliminating the need for structural members to support the collection bag off the ground.

It is still another object of the invention to provide a collection bag that includes an exhaust vent that permits air to pass through the bag, therefore maintaining the exhaust airflow generated by the mower attachment.

It is still another object of the invention to provide a collection bag made from a material that permits air to pass through it, therefore maintaining the exhaust airflow generated by the mower attachment.

It is still another object of the invention to provide a collection bag that can be reused after disposing of the collected grass and leaf clippings.

It is still another object of the invention to provide a collection bag that can be disposed of with the collected grass and leaf clippings.

It is still another object of the invention to provide a collection bag that is biodegradable to be disposed of with the collected grass and leaf clippings.

It is still another object of the invention to provide a collection bag that can be reused after easily emptying the grass and leaf clippings through a large opening that is part of the bag.

These and other objects of the invention are achieved by constructing a large bag with the ability to easily attach to the exhaust chute of the mower attachment of the lawn tractor. The large bag collects the grass and leaf clippings while maintaining the necessary airflow by venting the airflow through the material the bag is manufactured from or a vent. The bag has a quick connector to permit easy attachment to and removal from the exhaust chute and will drag on the ground behind the lawn tractor, thereby eliminating the need for complex structural components to support the bag.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a perspective view of a lawn tractor with a grass and leaf collection bag in accordance with the present invention attached to the grass catcher and exhaust chute.

FIG. 2 is a plan view of a freestanding bag with drawstring top, in accordance with the present invention.

FIG. 3 is a partial perspective view of an alternative embodiment of the invention, in which the venting mechanism for the grass and leaf collection bag is provided in the exhaust chute of the lawn tractor.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents, which operate in a similar manner to accomplish a similar purpose.

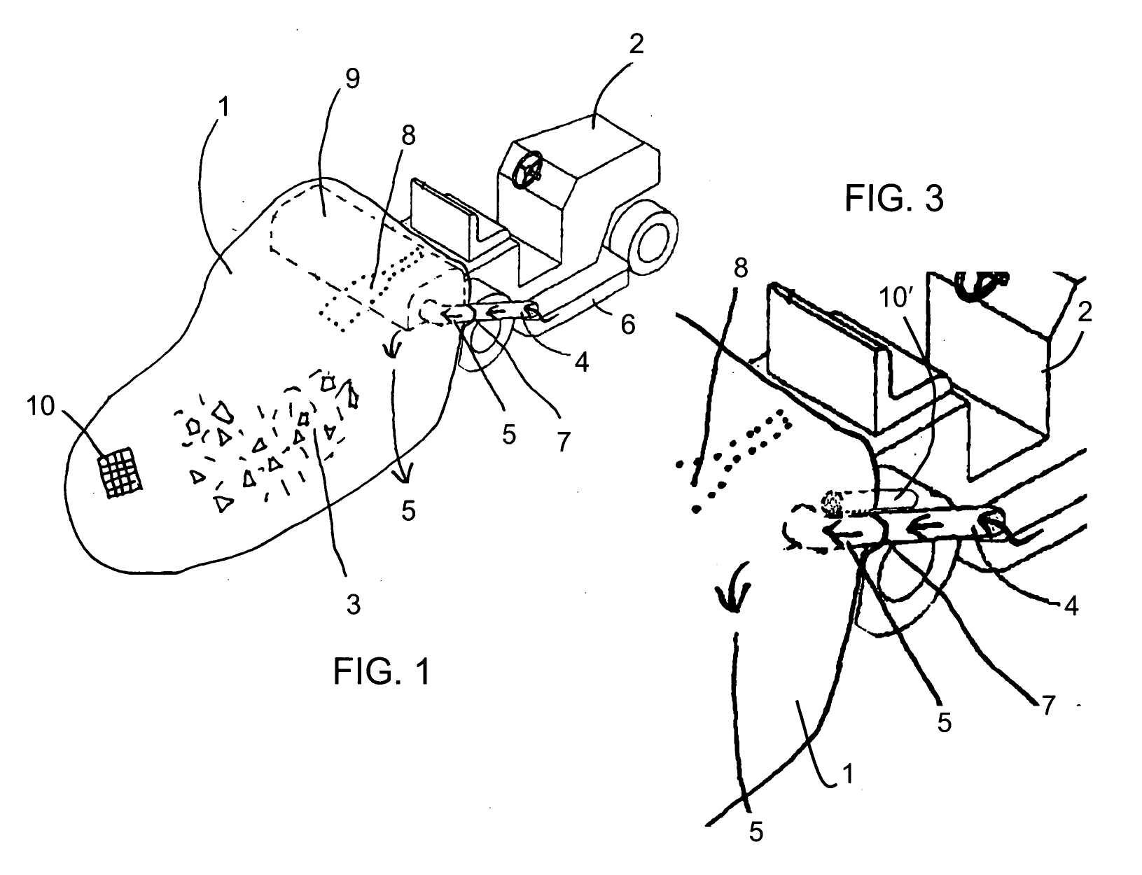

Referring to FIG. 1, there is shown a grass and leaf collector bag 1 in accordance with the present invention attached to a conventional lawn tractor 2 having an exhaust chute 4 for expelling leaves and grass 3 picked up by a mower attachment 6. The lawn tractor 2 may also have an optional grass catcher hood 9. It is the basic function of the bag to collect the leaves and grass 3 expelled from the exhaust chute 4 by airflow (indicated by arrows 5) generated by the mower attachment 6 on the lawn tractor 2.

As shown in FIG. 1, the grass and leaf collector bag 1 is easily attached to the exhaust chute 4 by a quick connector 7, in this example a drawstring, and hangs off the backside of the lawn tractor 2 and is dragged on the ground behind it. The grass and leaf collector bag 1 can be connected to the frame of the lawn tractor 2 by a connecting strap 8 if desired. In instances where the optional grass catcher hood 9 is already in place the grass and leaf collector bag 1 is opened and passes around the optional grass catcher hood 9 enclosing the hood.

The primary components of the grass and leaf collector bag 1 are the quick connector 7 at the open end of the bag, the material from which the grass and leaf collector bag 1 is manufactured, an optional connecting strap 8, and a large opening 11 to permit easy emptying of the contents, in this case controlled by the quick connector 7.

The preferred characteristics of the material from which the grass and leaf collector bag 1 is manufactured are that it permits the airflow 5 generated by the mower attachment 6 and exiting through the exhaust chute 4 to pass through the material of the grass and leaf collector bag 1, that it is flexible enough to permit the quick connector 7 to work properly, strong enough to carry the estimated weight of the leaves and grass 3 contained therein, and durable enough to withstand being dragged along the ground without receiving significant damage during the expected life of the bag. Examples of specific materials include but are not limited to cloth sheeting that is 50% cotton and 50% polyester with a thread count of 200. It is preferable to use a fabric that is undyed, or that has very little dye, as too much dye may reduce the airflow through the grass and leaf collector bag 1.

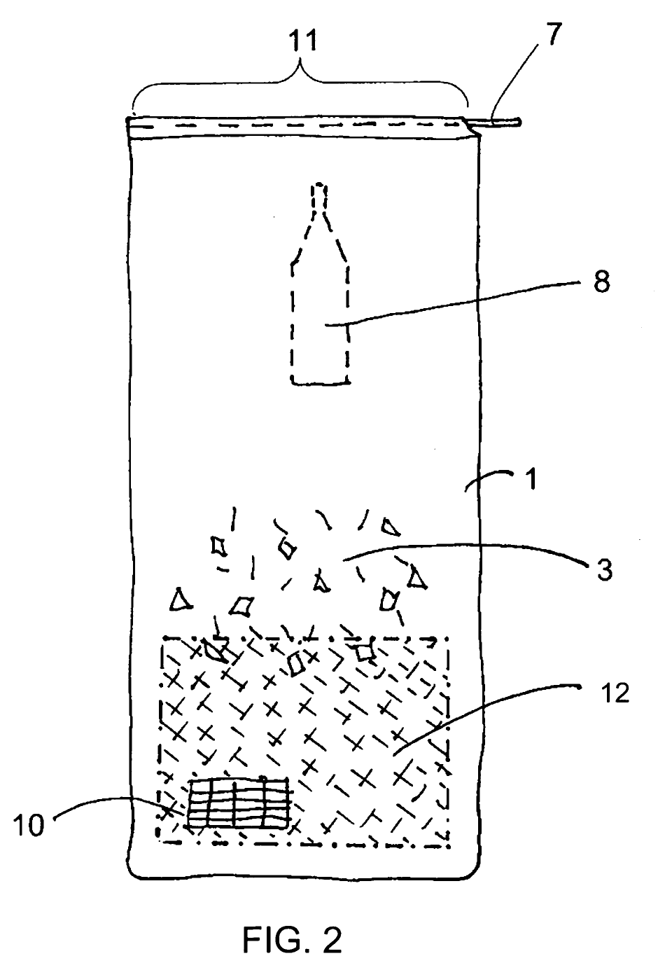

The wear to the material from which the grass and leaf collector bag 1 is manufactured can be reduced by affixing at least one layer of a wear-resistant material 12 to the underside of the bag 1, as shown in FIG. 2.

Alternatively, the grass and leaf collector bag 1 can be made of a material that is biodegradable to be disposed of with the collected grass and leaf clippings.

In instances where the material from which the grass and leaf collector bag 1 is manufactured does not permit the airflow 5 to pass through properly, another, separate venting means 10 can be also be used. This separate venting means 10 can be incorporated into the grass and leaf collector bag 1 as shown in FIGS. 1 and 2, or another device, as described hereinafter. The proper airflow 5 generated by the mower attachment 6 is identified by the characteristics that the material allows the grass and leaf collector bag 1 to inflate to permit the leaves and grass 3 to be distributed throughout the grass and leaf collector bag 1 while minimizing backpressure in the exhaust chute 4. An optional connector strap 8 can be used to connect the grass and leaf collector bag 1 directly to the frame of the lawn tractor 2 for better control of the grass and leaf collector bag 1 when it is dragging on the ground behind the lawn tractor 2.

In FIG. 2 grass and leaf collector bag 1 is shown independent of the lawn tractor 2 to show the large opening 11 that permits easy emptying of the contents. Shown here is an example of the large opening 11 being controlled by the quick connector 7, which is a drawstring in this example. The large opening 11 can be located anywhere on the grass and leaf collector bag 1 that permits easy emptying of the contents and as long as there is a means to open and close the large opening 11. Also shown is the optional connector strap 8 used to connect the grass and leaf collector bag 1 directly to the frame of the lawn tractor 2 and the separate venting means 10.

In operation the leaves and grass 3 are expelled from the exhaust chute 4 by the airflow 5 generated by the mower attachment 6 on the lawn tractor 2. The grass and leaf collector bag 1 is attached to the exhaust chute 4 by the quick connector 7, in this example a drawstring, and hangs off the backside of the lawn tractor 2 and is dragged behind the lawn tractor 2 on the ground. As the airflow 5 passes through the material from which the grass and leaf collector bag 1 is made, or through a separate venting means 10, the leaves and grass 3 are collected inside the grass and leaf collector bag 1.

The separate venting means 10 is shown in FIGS. 1 and 2 as a screen type material of a fixed size that is set into an opening in the bag and that permits airflow to pass through it while prohibiting the grass and leaves 3 from exiting. When the grass and leaf collector bag 1 is full the leaves and grass 3 can be emptied using the large opening 11 or the grass and leaf collector bag 1 and the leaves and grass 3 can be disposed of together.

Alternatively, the venting means 10 can be constructed to provide variable amounts of airflow by sliding or twisting to provide different volumes of airflow therethrough. This would permit one size bag to be adjusted to work with different size mower attachments.

In another alternative embodiment, as shown in FIG. 3, the venting means 10′ can be part of the exhaust chute 4 and in direct communication with the leaf collector bag 1.

The size of the grass and leaf collector bag 1 is determined by the proper airflow 5 passing through the material or venting means 10, the size of the exhaust chute 4, and the size of the optional grass catcher hood 9 over which the leaf collection bag would need to pass. The proper airflow 5 needs to be adequate to deliver the leaves and grass 3 throughout the leaf collection bag 1. If the grass and leaf collector bag 1 is too large the airflow 5 generated by the mower attachment 6 will dissipate and not deposit the leaves and grass 3 throughout the grass and leaf collector bag 1. If grass and leaf collector bag 1 is too small, the airflow 5 generated by the mower attachment 6 will cause backpressure in the exhaust chute 4 and the leaves and grass 3 will not be expelled from the exhaust chute 4, resulting in the leaves and grass 3 clogging the exhaust chute 4.

In a working embodiment constructed to test the invention, the grass and leaf collector bag 1 was made of cloth sheeting that was 50% cotton and 50% polyester with a thread count of 200 and tan in color. It was 48 inches wide and 96 inches long and provided the proper airflow 5 with the lawn tractor used in testing. The quick connector 7 was a drawstring made from ¼ inch nylon cord with a spring-loaded, plunger style clasp.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A grass and leaf collector attachment for a lawn tractor having a mower attachment and an exhaust chute for expelling leaves and grass picked up by the mower attachment, the collector attachment comprising:
a bag;
connector means for connecting the bag to the exhaust chute of the tractor;
an opening in the bag sized to permit easy emptying of grass and leaves from the bag;
closure means for opening and closing the opening; and
venting means for permitting airflow generated by the mower attachment and exiting through the exhaust chute to pass through the bag;
the bag being made from material that is flexible enough to permit the connector means to work properly, that is strong enough to carry the estimated weight of the leaves and grass contained therein, and that is durable enough to withstand being dragged along the ground without receiving significant damage during the expected life thereof; and
the size of the bag being determined at least in part by the proper airflow passing through the venting means and the size of the exhaust chute.

2. The attachment of claim 1, wherein the venting means is provided by the structure of the material from which the bag is made.

3. The attachment of claim 2, wherein the material from which the bag is made is constructed to allow the bag to inflate to permit leaves and grass to be distributed therethrough while minimizing backpressure in the exhaust chute of the tractor.

4. The attachment of claim 1, wherein the venting means comprises a screen type material constructed to permits airflow to pass therethrough while prohibiting the grass and leaves from exiting.

5. The attachment of claim 1, wherein the venting means includes adjustment means for providing variable amounts of airflow therethrough.

6. The attachment of claim 1, further comprising a connecting strap for connecting the bag to the frame of the lawn tractor.

7. The attachment of claim 1, wherein the lawn tractor includes a grass catcher hood over which the bag must pass, and wherein the size of the bag is also determined by the size of the grass catcher hood.

8. The attachment of claim 1, wherein the connector means comprises an adjustable drawstring.

9. The attachment of claim 1, wherein the connector means also functions as the closure means.

10. The attachment of claim 1, further comprising at least one layer of a wear-resistant material affixed to the underside of the bag.

11. The attachment of claim 1, wherein the bag is made of a biodegradable material.

12. The attachment of claim 1, wherein the bag is made of a cotton-synthetic blend cloth sheeting material with a thread count of approximately 200.

13. A grass and leaf collector attachment for a lawn tractor having a mower attachment and an exhaust chute for expelling leaves and grass picked up by the mower attachment, the collector attachment comprising:
a bag;
connector means for connecting the bag to the exhaust chute of the tractor;
the bag being made from material that is flexible enough to permit the connector means to work properly, and that is strong enough to carry the estimated weight of the leaves and grass contained therein; and
the size of the bag being sufficiently small that the airflow generated by the mower attachment will deposit the leaves and grass throughout the bag, and sufficiently large that the airflow generated by the mower attachment will minimize backpressure in the exhaust chute.

14. The attachment of claim 13, further comprising venting means for permitting airflow generated by the mower attachment and exiting through the exhaust chute to pass through the bag.

15. The attachment of claim 13, further comprising means for emptying of grass and leaves from the bag.

16. A lawn tractor comprising:
a mower attachment;
an exhaust chute for expelling leaves and grass picked up by the mower attachment;
a grass and leaf collector attachment in accordance with claim 13 for collecting leaves and grass expelled by the exhaust chute; and
venting means in the exhaust chute and in direct communication with the bag of the collector attachment for venting air from the bag.

17. The lawn tractor of claim 16, wherein the bag further comprises means for emptying of grass and leaves from the bag.
